(19) United States
(12) Patent Application Publication
(10) Pub. No.: US 2016/0302241 A1
(43) Pub. Date: Oct. 13, 2016

(54) SYSTEM AND METHOD FOR COMMUNICATION WITH END USERS USING PRESENCE DETECTION

(71) Applicant: Bridge Holdings LLC, McLean, VA (US)

(72) Inventors: Mohammad Shihadah, McLean, VA (US); Amro Shihadah, McLean, VA (US); Harish Seshadri, San Francisco, CA (US); Bob Milani, Menlo Park, CA (US)

(73) Assignee: Bridge Holdings LLC, McLean, VA (US)

(21) Appl. No.: 15/095,812

(22) Filed: Apr. 11, 2016

Related U.S. Application Data
(60) Provisional application No. 62/146,072, filed on Apr. 10, 2015.

(51) Int. Cl. H04W 76/02; H04W 64/00; H04M 7/00; H04W 72/04

(52) U.S. Cl. CPC H04W 76/02; H04W 72/04; H04W 64/00; H04M 7/006; H04W 80/04

(57) ABSTRACT

A system and method useful in establishing communications between at least two devices determines the presence and location of a plurality of devices at a location associated with at least one wireless data network. The system can establish a communication channel between the devices to communicate without using the internet, and integrates with a VoIP communication infrastructure to alternatively communicate over the internet. In an embodiment, the system determines whether at least one device is capable of communicating with the other devices over the local network or via a VoIP protocol over the internet, and causes another device to display a status indicating which mode of communication is available for communicating with the at least one device.

This application is a non-provisional of and claims priority to U.S. Provisional Patent Application No. 62/146,072 filed Apr. 10, 2015, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of wireless networks, and in particular to a system and method for communicating with end users on a wireless network using geo-location.

### BRIEF DESCRIPTION OF THE DRAWINGS

FIG. 1 shows a block diagram illustrating publish and subscribe operations.

FIG. 2 shows a flow diagram illustrating a basic SIP Call Flow.

FIG. 3 shows a block diagram illustrating communication between devices via text chat, voice calls, and video calls using disparate WI-FI devices connected through the Internet.

FIG. 4 shows a block diagram illustrating an embodiment wherein the disclosed system and method can establish communication between devices via text chat, voice calls, and video as if the phone interaction was a local call.

FIGS. 5 and 6 show examples of a process by which location of devices can be determined and overlayed as the devices move through a map.

### DETAILED DESCRIPTION

Reference is made below in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of methods and devices for communicating with end users on a wireless network using geo-location. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Overall Description

In an embodiment, the presently disclosed system and method are composed of multiple components that provide the capability to communicate and interact with end-users users. It can also be configured to provide the ability to detect and display the current location of a user whether indoor or outdoor within a map. Such communication can be provided in various modes text as in Chat, Audio/voice, and video between devices within a specific Wi-Fi router over the industry standard Wi-Fi communication protocol. The presently described system and method do not require the Wi-Fi router to be connected to the Internet. The system can communicate using the Internet to other devices not necessarily present within the same Wi-Fi network. In an embodiment, an application in accordance with the presently disclosed invention is interoperable between different mobile platforms, such as Apple's iOS, Google's Android operating system, and Microsoft Windows.

Main Functionality

The presently disclosed system and method can determine presence detection for devices on the Wi-Fi, establish communication channels between devices to chat in text, audio/voice talk, video calls, determine location of devices as related to Wi-Fi routers and repeaters, encrypt communications, and integrate with VoIP communication infrastructure to communicate over the Internet.

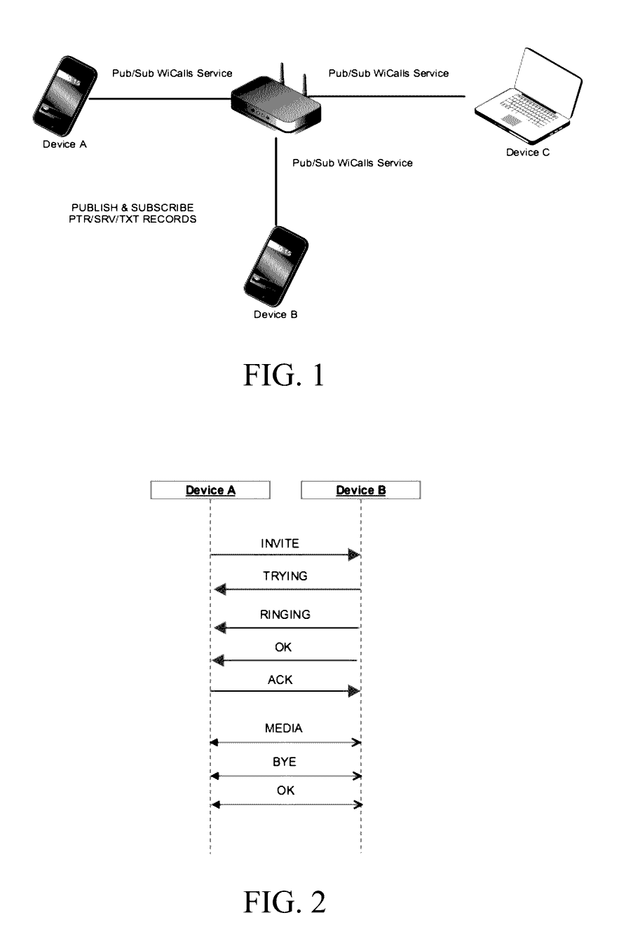

With reference to FIG. 1, a first functionality is to publish and discover smart devices using the presently disclosed system and method in the respective Wi-Fi. Using service-specific records, the presently disclosed system and method can publish itself as a network service. Pointer records, also known as PTR records, allow the discovery of services in the local domain. Service locator records, also known as SRV records, help convert a service instance name, type, and domain into a hostname and port. Optional text records, also known as TXT records, provide more information about the publish service. This is an efficient multicast mechanism.

The presently disclosed system and method may utilize the SIP protocol for establishing sessions between peers (p2p). With reference to FIG. 2, the basic SIP Call Flow is as follows. Device A sends an initial INVITE packet to Device B. This INVITE packet contains headers with signaling information (addresses/phone numbers/SIP URI) information. The INVITE packet also implements the Session Description Protocol (SDP). The SDP is a body with information regarding the media settings that a device A supports (codecs) and media addresses. When Device B SIP proxy receives the INVITE, it sends back a “Trying” SIP response, which means that it has accepted the INVITE and it processes it. When Device B starts ringing, a “Ringing” is sent back to notify device A.

When device B answers the phone, an “OK” SIP message is sent back to device A. This message contains a SDP body with the media settings that device B supports (codecs). Device A and Device B essentially negotiate these media parameters that will be used during the call. Finally device A replies with an ACK in order to confirm that the OK” has been received. From that moment, the two parties can start a media session with each other using the negotiated media parameters. When one of the parties releases the call, a BYE message is sent to the other party who in turn sends back an “OK” to confirm the call release.

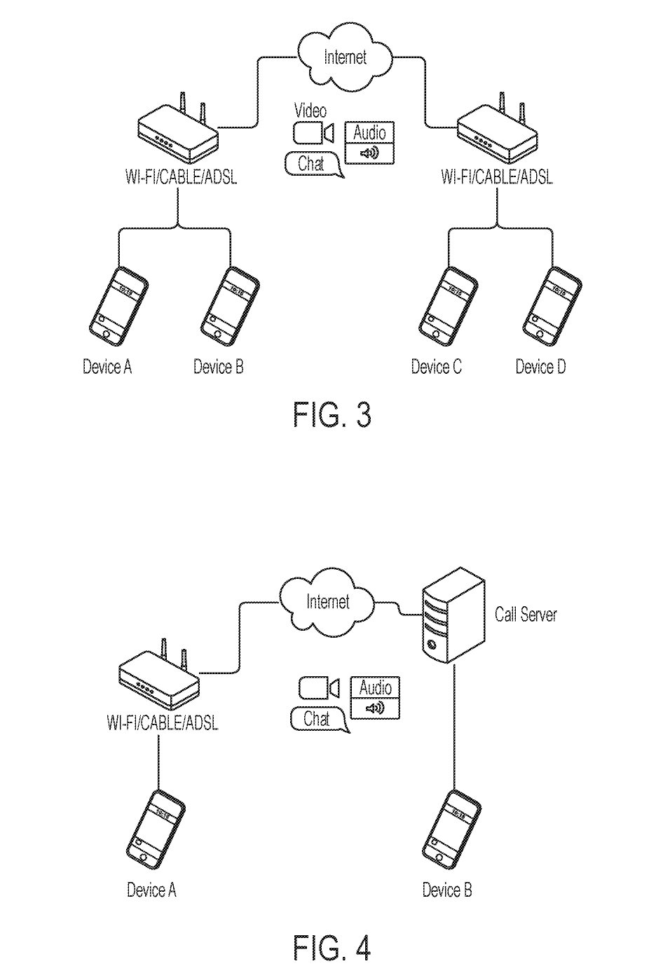

With reference to FIG. 3, the system and method can establish communication between devices via text chat, voice calls, and video calls using disparate WI-FI devices connected through the Internet.

In an embodiment, the presently disclosed system and method can establish communication between devices via text chat, voice calls, and video as if the phone interaction was a local call. See FIG. 4.

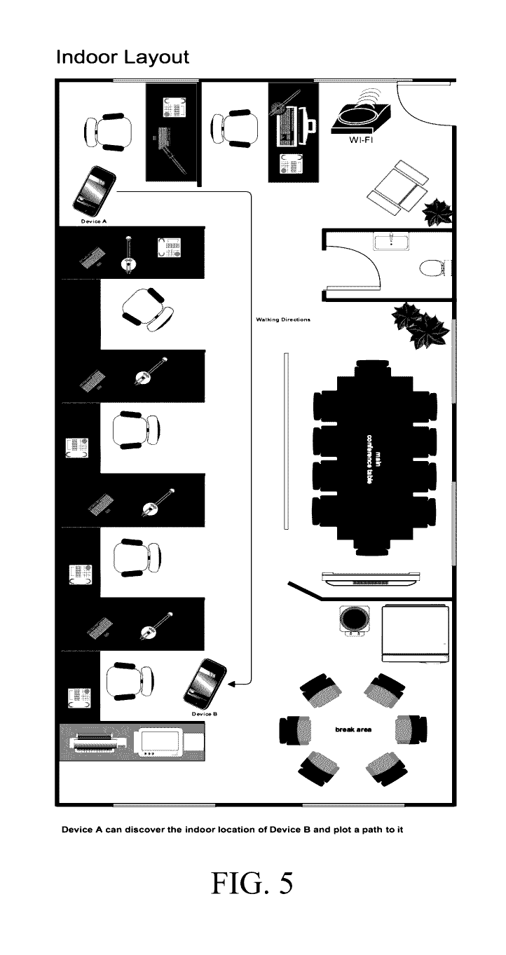

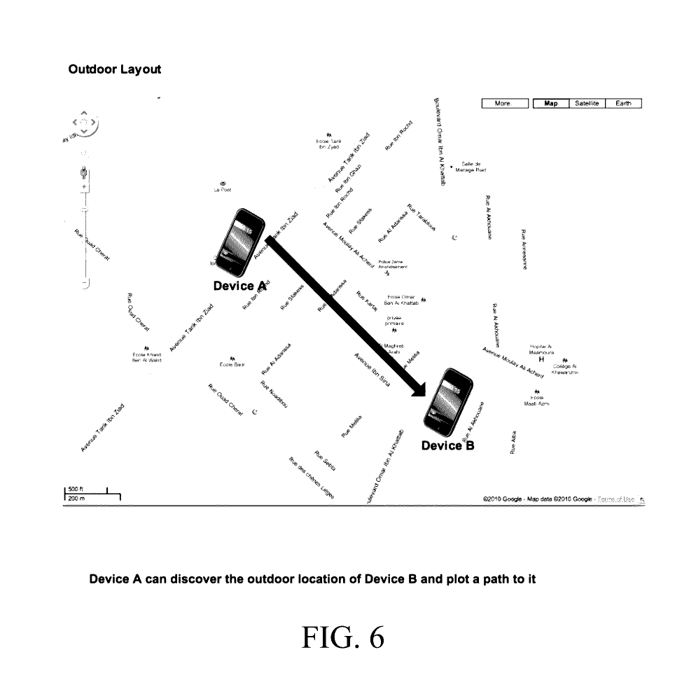

The presently disclosed system and method can determine and overlay location of devices as they move through a map. Indoor mapping and outdoor mapping are both tracked and mapped. Furthermore, walking/driving directions can be dynamically provided between the devices as they are moving. There is no need for a static physical address since the current locations of the devices are used. See FIGS. 5 and 6.

All communication can be encrypted between the connected devices. For the secure transmission of media streams (voice, video) SIP uses the Secure Real-time Transport Protocol (SRTP). For secure transmissions of SIP messages, the protocol is encrypted with Transport Layer Security (TLS).

Load Balancing—Dynamic bandwidth usage is based on the number of connected devices, the device priority and bandwidth usage. The bandwidth usage per device on a Wi-Fi network is stored in a metrics database connected to the Internet.

Feature List
a. Presence detection
   i. Detect if user is onsite.
   ii. Detect distance from access point (correlate with blueprint to show location in venue)
      1. Detect presence or lack of presence in a specific location i.e. hotel room so the power turns on or off
b. Communication
   i. Chat/Messenger
      1. one to one
      2. Group messaging
   ii. Audio (streaming & push to talk)
      1. One to one
      2. Conference
   iii. Video (canned & streaming)
      1. One to one (Facetime clone)
      2. One to many (streaming or canned video)
   iv. Image (Upload or take a photo)
      1. One to one or one to group

In an embodiment, the presently disclosed system and method can determine and display status, i.e., how contact can be made to a user. The system may, for example, display a user's status as “Wi-call”, “Internet”, and/or “Data”. If a user's status is “Wi-Call,” other users on the same local Wi-Fi network can communicate directly with the user over that network. If the user's status is “Internet”, other users can communicate with the user using the internet connection. If the User's status is “Data,” other users can communicate with the user via a mobile data connection. If a user's status is “Offline/Unavailable,” no communication with that user is available.

In an embodiment, the system and method can utilize Contacts on a user's device in various manners. The system and method may import all contacts individually and as defined in Groups from the device's contacts information. Optionally, the system and method can show the user's presence to other users that are around the user using Presence technology based on user's contact list. Each use that is determined to be present can be displayed with their photo or dynamically created icon. Optionally, the presently disclosed system and method can show to a user all devices on which other users accepted “Public Presence” via an option. Presence detection may be accomplished, for example, using AKA. The system and method may be configured to show those that are available via Wi-Fi messaging protocols such as those used by viber and whatsapp. The system and method described herein may also show a user those contacts that he must use data for, e.g., those contacts that are not signed up to use the present system or who are offline. In an embodiment, the presently disclosed system and method can be configured to import or create groups such as family, friends A, Friends B, Company, Department, etc.

Further features of the invention include:
a. Ability to work with a Specific Proxy Server
b. The system can be connected to local PBX
c. Can provide local Webserver or local CDN
d. Can operate over VoIP.
e. Can operate over VoIP connected to physical cellular network.
f. Can operate over VoIP connected to MVNO.
g. Can provide local number capabilities
h. Can be used for verticals as customized and developed with customized capabilities. Some examples of these verticals are: Hotels, Hospitals, Malls, Company Offices, Connected City, expos (connect to registered attendees list), and conferences.
i. A feature referred to herein as WiHop can use a proxy server, Wi-Fi routers or connected devices.

Examples of System Configured for Hotels

When iOS native devices are being used, Apple's “Core Location” along with the M7 (or higher) motion chip can enable the software to notify if a guest is on or off-site and provide real-time data on indoor positioning or presence and navigation or guest movement.

If a guest is using Android or other operating systems devices the system and method described herein can provide even more granular data including indoor position, navigation, and notifications based on locations—3 dimensional data.

Capabilities based on guest connectivity (all of which may need an application layer for delivery) include:
a. “Data” or “Wi-Fi Open” - complete presence capabilities available (indoor 3D presence and navigation)
b. “Wi-Fi Closed” (local no connectivity) - complete presence capabilities available, guest simply needs to connect to the router and is not required to login or register. Can provide same real-time presence and navigation.

Presence—Hardware Based Solution for Hotels

Using the presently disclosed system and method in combination with beacon technology can provide the highest level of detailed data, including positioning/presence and navigation as well as location based real-time automated push notifications.

Benefits and Use-Cases

Using any of the above-described presence solutions in combination with guest/user profiles, the system can provide hotels with a guest's real-time positioning (presence), navigation or movement. This data can be leveraged to thicken revenue streams, improve guest services and increase the value of feedback.
a. Revenue Generation—Push localized promotions by tracking movement and delivering targeted promotions with perfect timing. Use case: Guest walks by the spa, location notification triggers the app to send a notification to the guest that there is a discounted appointment in 30 minutes.
b. Improved Guest Experiences & Value of Feedback: by providing the exact location, nature of the request, and guest information in real-time—hotel staff can complete services in a much more personalized manner thus increasing the likelihood of positive feedback which can be cross-referenced with our data unlocking unique insights that create targeted data—such as where, when, and by whom the feedback was given which is more valuable then the current general reviews and non-attributable increases in ratings.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A method useful in establishing communications between at least two devices, the method comprising:
determining presence of a plurality of devices at a location associated with at least one wireless data network;
establishing a communication channel between at least two of said devices to communicate in at least one of: an audio/voice protocol, a video protocol, a text protocol, or an image protocol;
determining location of at least one of said devices relative to at least one wireless network router or repeater; and,
integrating with a VoIP communication infrastructure to communicate over the internet.

2. The method of claim 1, wherein the step of establishing a communication protocol comprises using a SIP protocol to establish a session between peers.

3. The method of claim 1, further comprising steps of:
determining whether at least one of said devices is capable of communicating with at least one other device via the communication channel without using the internet;
determining whether the at least one device is capable of communicating with the other device via a VoIP protocol over the internet;
causing the at least one other device to display the at least one device's status, the status indicating whether the at least one device is available to communicate via the communication channel without using the internet or via a VoIP protocol over the internet.

4. The method of claim 1, further comprising steps of:
determining a current location of at least one of said devices within a map;
causing at least one other of said devices to display said current location within the map.

5. The method of claim 1, wherein said wireless network router or repeater comprises a Wi-Fi router or repeater.

6. The method of claim 1, wherein the location associated with at least one wireless data network comprises a hotel.

7. The method of claim 1, wherein the location associated with at least one wireless data network comprises a hospital.

8. The method of claim 1, wherein the location associated with at least one wireless data network comprises a mall.

9. The method of claim 1, wherein the location associated with at least one wireless data network comprises a company office.

10. The method of claim 1, wherein the location associated with at least one wireless data network comprises a connected city.

11. The method of claim 1, wherein the location associated with at least one wireless data network comprises an exposition.

12. The method of claim 1, wherein the location associated with at least one wireless data network comprises a conference.

13. The method of claim 1, further comprising the step of:
encrypting communications on said communication channel between said at least two devices.
